(19) United States
(12) Patent Application Publication
(10) Pub. No.: US 2021/0342740 A1
(43) Pub. Date: Nov. 4, 2021

(54) SELECTIVELY TRANSMITTING ELECTRONIC NOTIFICATIONS USING MACHINE LEARNING TECHNIQUES BASED ON ENTITY SELECTION HISTORY

(71) Applicant: Microsoft Technology Licensing, LLC, Redmond, WA (US)

(72) Inventors: Zhiyuan Xu, Mountain View, CA (US); Jinyun Yan, Sunnyvale, CA (US); Ajith Muralidharan, Sunnyvale, CA (US); Wensheng Sun, Sunnyvale, CA (US); Jiaqi Ge, Sunnyvale, CA (US); Shaunak Chatterjee, Sunnyvale, CA (US)

(21) Appl. No.: 16/866,059

(22) Filed: May 4, 2020

(51) Int. Cl. G06N 20/00; G06F 16/9535; G06N 7/00

(52) U.S. Cl. CPC G06N 20/00; G06N 7/005; G06F 16/9535

(57) ABSTRACT

Techniques for selectively transmitting electronic notifications using machine learning techniques based on entity selection history are provided. In one technique, a candidate notification is identified for a target entity. An entity selection rate of the candidate notification by the target entity is determined. Based on the candidate notification, determining a probability of the target entity visiting a target online system. Based on online history of the target entity, a measure of downstream interaction by the target entity relative to one or more online systems is determined. Based on the entity selection rate, the probability, and the measure of downstream interaction by the target entity, a score for the candidate notification is generated. Based on the score, it is determined whether data about the candidate notification is to be transmitted over a computer network to a computing device of the target entity.

### TECHNICAL FIELD

The present disclosure relates to machine learning and, more particularly to, intelligently transmitting electronic notifications over a computer network based on multiple objectives.

### BACKGROUND

Content platforms provide a platform where users may share and consume content. Content platforms monitor content related to users and notify users when content is ready to be consumed. For example, content platforms may notify a user when the user has pending content items in their feed, pending invitations to connect with other users, and any other content item update that may be of interest to the user. Notifications are sent to users to inform users of the pending content. In response, users may initiate a new user session on the content platform to interact with pending content.

Content platforms dedicate significant resources to generating and sending notifications to users in order to cause users to engage with the content platform by initiating a new user session. If a content platform sent a notification for every possible event that occurred that might be of interest to each user, then the computing resources of the content platform may be overwhelmed. Also, receiving many notifications may result in users not engaging with the content platform. Thus, such a naive approach to transmitting notifications to users is not optimal.

In another approach, a content platform may optimize when notifications are sent to users based upon many factors, such as the amount of pending content for the user and the frequency in which the user engages in a user session. Metrics for such factors allow content platforms to schedule notifications in order to maximize the probability that a user will initiate a new user session. However, initiating a new user session does not guarantee that the new user session results in quality user engagements. User sessions may include very short sessions, where a user engages in few (if any) activities and may only be online for a few seconds, or longer sessions, where a user engages in many different activities and the session lasts for several minutes. Shorter user sessions may not result in the level of engagement desired by the content platform. Also, shorter sessions are a sign of user dissatisfaction in the content platform. Therefore, conventional approaches to optimize notifications to increase the probability of a new user session may not result in the desired effect of increasing user engagement.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for distributing content items to one or more end-users, in an embodiment;

FIG. 2 is a flow diagram that depicts an example process for presenting a candidate notification to a target entity, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

A system and method for selectively transmitting electronic notifications over one or more computer networks are provided. In one technique, a computer system considers multiple objectives when determining whether to transmit an electronic notification over a computer network. Example objectives include notification selection, online sessions or visits, and downstream utilities that flow from an online session or visit, such as specific types of activities. Examples of such activities include engagement with certain types of content items. Values for one or more of the objectives for a particular candidate notification may be generated using one or more machine-learned models that have been trained based on electronic notification selection history and/or electronic content item-specific engagement history.

Embodiments improve computer-related technology by configuring processes within a computer system to account for multiple objectives when determining whether to send a candidate notification over a computer network to one or more entities. Traditionally, sending all possible electronic notifications results in overburdening system resources and the computer network. Limiting the number of electronic notifications transmitted to an entity with hard-coded rules does not take into account a likelihood of the entity selecting the electronic notification nor other downstream effects of notification selection. Thus, embodiments involve a data driven approach, for determining whether to transmit an electronic notification over a computer network, that does not overburden system resources and that takes into account multiple objectives.

System Overview

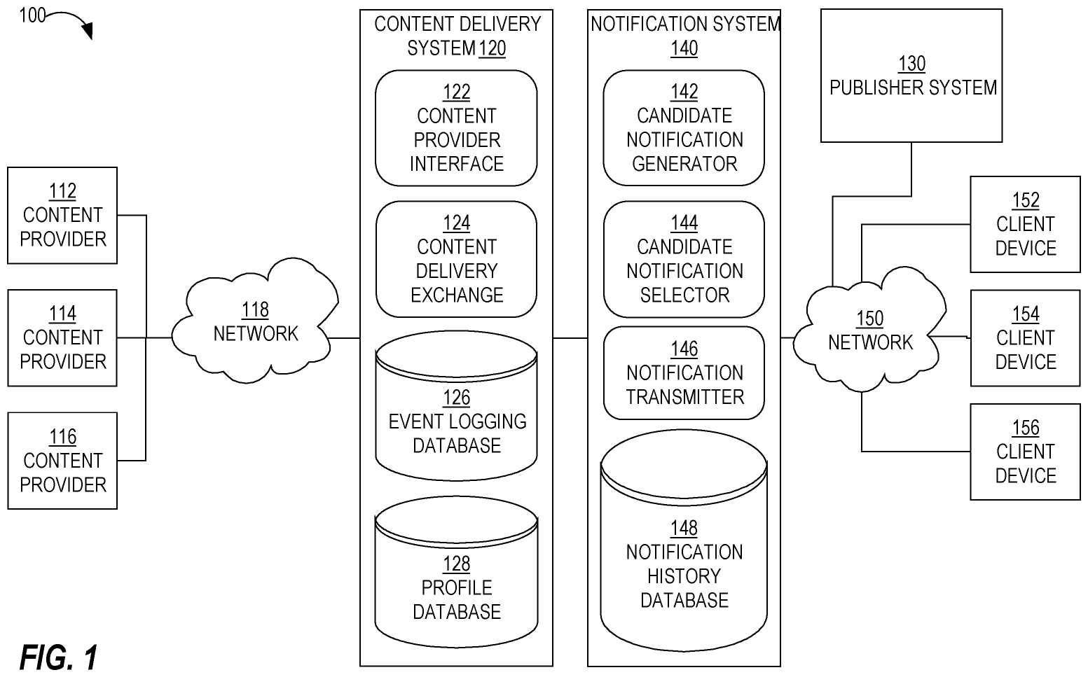

FIG. 1 is a block diagram that depicts a system 100 for distributing content items to one or more end-users, in an embodiment. System 100 includes content providers 112-116, a content delivery system 120, a publisher system 130, a notification system 140, and client devices 152-156. Although three content providers are depicted, system 100 may include more or less content providers. Similarly, system 100 may include more than one publisher and more or less client devices.

Content providers 112-116 interact with content delivery system 120 (e.g., over a network 118, such as a LAN, WAN, or the Internet) to enable content items to be presented, through publisher system 130, to end-users operating client devices 152-156. Thus, content providers 112-116 provide content items to content delivery system 120, which in turn selects content items to provide to publisher system 130 for presentation to users of client devices 152-156. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content (over network 150) to client devices 152-156 in response to requests initiated by users of client devices 152-156. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 152-156 include desktop computers, laptop computers, tablet computers, wearable devices, video game consoles, and smartphones.

Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include ΔppNexus, DoubleClick, and Linkedln. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

Content Delivery Campaigns

Each content provider establishes a content delivery campaign with content delivery system 120 through, for example, content provider interface 122. An example of content provider interface 122 is Campaign Manager™ provided by Linkedln. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 152-156. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from June 1, 2015 to August 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

Event Logging

Content delivery system 120 may log one or more types of events, with respect to content items, across client devices 152-156 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or an interaction data set. Thus, content delivery system 120 may include an event logging database 126. Logging such events allows content delivery system 120 to track how well different content items and/or campaigns perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery campaign (or multiple content items from the same content delivery campaign), content delivery system 120 may calculate a user interaction rate for the content delivery campaign. Additionally, from interaction data items and impression data items associated with a content provider (or content items from different content delivery campaigns initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

Profile Database

While FIG. 1 depicts profile database 128 as being part of content delivery system 120, profile database 128 may be part of publisher system 130 or notification system 140, or may be separate from any of the depicted systems.

Profile database 128 stores multiple entity profiles. Each entity profile in profile database 128 is provided by a different entity. Example entities in the profile context include users, groups of users, and organizations (e.g., companies, associations, government agencies, etc.). Each entity profile is provided by a different user or group/organization representative. An organization profile may include an organization name, a website, one or more phone numbers, one or more email addresses, one or more mailing addresses, a company size, a logo, one or more photos or images of the organization, an organization size, and a description of the history and/or mission of the organization. A user profile may include a first name, last name, an email address, residence information, a mailing address, a phone number, one or more educational/academic institutions attended, one or more academic degrees earned, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider).

Some data within a user's profile (e.g., work history) may be provided by the user while other data within the user's profile (e.g., skills and endorsement) may be provided by a third party, such as a “friend,” connection, colleague of the user.

Users may be prompted to provide profile information in one of a number of ways. For example, a web page is presented to the user with a text field for one or more of the above-referenced types of information. In response to receiving profile information from a user's device, the information is stored in an account that is associated with the user and that is associated with credential data that is used to authenticate the user to publisher system 130 when the user attempts to log into publisher system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, access data is stored in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically (e.g., by publisher system 130 or another automatic process). For example, a user specifies, in his/her profile, a name of the user's employer. Publisher system 130 determines, based on the name, where the employer and/or user is located. If the employer has multiple offices, then a location of the user may be inferred based on an IP address associated with the user when the user registered with a social network service (e.g., provided by publisher system 130) and/or when the user last logged onto the social network service.

Notification System

Notification system 140 is a computer system that causes electronic notifications (hereinafter “notifications”) over one or more computer networks to client devices, such as client devices 152-156. Notification system 140 includes a candidate notification generator 142, a candidate notification selector 144, a notification transmitter 146, and a notification history database 148. Each of candidate notification generator 142, candidate notification selector 144, and notification transmitter 146 may be implemented in software, hardware, or a combination of software and hardware.

Notification System: Candidate Notification Generator

Candidate notification generator 142 generates candidate notifications for different entities. Candidate notification generator 142 stores type data about different types of notifications for an entity, such as notifications about work anniversaries of friends/connections of the entity, notifications about new positions of connections of the entity, notifications about birthdays of connections of the entity, notifications about shares (e.g., notifications of online shares of posts by connections of the entity), notifications about searches (e.g., a number of searches that includes the entity in the corresponding results), notifications abouts profile views (e.g., who has viewed the entity's online profile), notifications about comments (e.g., notifications of posts in which a connection of the entity provided a comment).

Candidate notification generator 142 analyses online activity and/or entity profiles to identify candidate notifications. For example, candidate notification generator 142 identifies a particular entity whose online (e.g., public) profile indicates a birthday on the current date. Candidate notification generator 142 identifies all connections of the particular entity and generates a candidate notification for each identified connection. The candidate notification includes data about the particular entity (e.g., an entity identifier that uniquely identifies the particular entity), type data that indicates the notification type is birthday, and data about an entity recipient (e.g., an entity identifier that uniquely identifies the entity recipient)

As another example, candidate notification generator 142 identifies a particular entity that commented on an online posting provided by another entity. Candidate notification generator 142 identifies all connections of the particular entity and generates a candidate notification for each identified connection. The candidate notification includes data about the particular entity (e.g., an entity identifier that uniquely identifies the particular entity), type data that indicates the notification type is comment, and data about an entity recipient (e.g., an entity identifier that uniquely identifies the entity recipient).

A candidate notification may contain less information or data than an actual notification that is sent as a result of the candidate notification. For example, an actual notification may contain a profile image while a candidate notification contains an entity identifier that may be used to retrieve the profile image (of the entity) after it is determined that the candidate notification should be transmitted to the intended recipient.

Notification System: Candidate Notification Selector

Candidate notification selector 144 selects candidate notifications for transmission to their respective intended recipients. Thus, candidate notification selector 142 does not send every candidate notification to its intended recipient. Candidate notification selector 142 may implement rules that prevent a single entity, an entity segment (comprising multiple entities), and/or all entities from receiving a threshold number of notifications. For example, candidate notification selector 142 may apply a first rule that indicates that a recipient should receive no more than five notifications per day, a second rule that indicates that an entity segment should receive no more than one hundred notifications per day, and a third rule that indicates that no more than one thousand notifications should be transmitted on any given day. The rules may apply to time periods other than a day (or 24 hours), such as the last six hours, the last two days, the last week, the last month, etc.

As described in more detail herein, candidate notification selector 144 leverages one or more machine-learned models that are used to score candidate notifications. Scored candidate notifications (e.g., intended for a particular entity) may be ranked relative to each other and the top N notifications are transmitted to a computing device (or account) of the particular entity. Additionally or alternatively, any candidate notification whose score is above a particular threshold is transmitted to the corresponding entity, subject, optionally, to any rules limiting the number of notifications received in a certain period of time.

Notification transmitter 146 causes a notification to be transmitted to an entity. “Transmitting a notification to an entity” may involve transmitting details of the notification over a computer network to an entity. An example of such a transmission is a push notification where receipt of the notification by a computing device triggers details of the notification to be presented on a display of the computing device. The display process may be through an operating system of the computing device. Selection of a push notification causes details of the notification to be presented on the computing device, through a client application that manages notifications of the entity. The client application may be a native application that is installed on the computing device or a web application that executes within a web browser that is installed on the computing device.

Another example of “transmitting a notification to an entity” may involve causing an icon representing a native application to be updated to indicate that a notification is available. This is referred to as an “in-app” notification. A badge may appear adjacent to or on top of the icon and may include a number indicating the number of pending notifications. A “pending notification” for an entity is a notification that has not yet been presented to the entity.

A “selected notification” is a notification that has been selected by the intended recipient entity. An “unselected notification” is a notification that has been presented to the intended recipient but has not yet been selected by the intended recipient. Thus, a notification may transition between the following states: candidate, pending, unselected, and selected. More details of a notification may be included in a selected version of the notification than an unselected version of the notification.

If there are one or more pending notifications when a new notification is transmitted and a badge indicates the number of pending notifications, then the number increases by one. If there are no pending notifications when the new notification is transmitted, then the badge may appear and, optionally, indicates one. The entity selecting the icon causes the native application to launch or open. A notifications view may be the first view, which presents a list of notifications, where unselected notifications may be presented differently than selected notifications. Alternatively, a content item feed (comprising content items unrelated to notifications) may be the first view presented to the entity upon the entity selecting the icon. However, the client application may present a user interface that indicates a notifications tab or view and (another) badge that indicates that one or more pending notifications are available for the viewing entity.

In an embodiment, one or more machine-learned models (as described in more detail herein) are used to determine whether to transmit candidate in-app notifications to target entities while simple rules (e.g., only based on notification type and frequency) are used to determine whether to transmit push notifications to target entities.

Another example of “transmitting a notification to an entity” involves associating the notification with an account of the entity so that the entity, upon viewing his/her account, may view the notification. The notification (and any other pending, unselected, or selected notifications) may be viewed through a notifications tab visible in a user interface (provided by the client application) presented to the user.

Notification System: Notification History Database

Notification history database 148 comprises data about selections and/or presentations of transmitted notifications. The data in notification history database 148 may be organized by entity, by date, or by any combination of characteristics or attributes of notifications. For example, a record for a notification in notification history database 148 may include the following information: a notification identifier that uniquely identifies the notification, a target entity identifier that uniquely identifies an entity that is the target or intended recipient of the notification; a source entity identifier that uniquely identifies an entity that is the source (or initiator) of the notification; a timestamp that indicates when the notification was transmitted to the target entity; selection data that indicates whether the target entity selected the notification and, if so, when the selection occurred; presented data that indicates whether the notification was presented to the target entity and, if so, when the presentation occurred; type data indicating a type of notification (e.g., birthday, work anniversary, share, comment); a session identifier that uniquely identifies a session that the target entity had with publisher system 130 (or another computing system) in response to the target entity selecting the notification; and detail data that indicates details of the notification, such as a number of years of a work anniversary, a job title, and a company name (in the case of a work anniversary) or an excerpt from a post that the source entity shared and a post identifier that uniquely identifies the post (in the case of a share).

When a notification is presented to a target entity, not all the details may be presented (e.g., a portion of a post that was shared). however, if the target entity selects the notification, then all the relevant details (but excluding identifiers that are used, for example only by notification system 140) may be presented to the target entity.

Based on records stored in notification history database 148, notification system 140 may calculate various statistical information, such as a number of notifications presented to a target entity (e.g., in the last 48 hours), a number of notifications selected by a target entity (e.g., in the last week), a notification selection rate of a target entity (e.g., over the last month), a notification selection rate of notifications initiated by a source entity (e.g., over the last month), a notification selection rate of a target entity for notifications of a particular type (e.g., birthdays) (e.g., over the last two weeks), etc. When generating a statistic pertaining to notifications that were transmitted within a specific time period (e.g., the last 24 hours), the timestamp of each notification may be examined to ensure that the timestamp indicates a time that is within the specific time period.

Candidate Notification Selection

As noted previously, candidate notification selector 144 considers multiple factors when determining whether to select a candidate notification for transmission to a target entity. Some factors may correspond to different objectives. For example, one objective may be to maximize the number of entity selections of notifications when the notifications are transmitted to target entities. An example of an entity selection of a notification is the entity “clicking on” the notification (a) by placing a finger on a touchscreen display or (b) by clicking a button of a cursor control device while the cursor is hovering over the notification. One way to maximize the number of entity selections is to make a prediction of whether a target entity will select a candidate notification. The higher the prediction, the more likely candidate notification selector 144 will select the candidate notification for transmission to the target entity.

A prediction of selection may be made in multiple ways. For example, candidate notification selector 144 (or another computing element) computes a notification selection rate of an entity. If the notification selection rate of an entity is greater than a certain threshold, then a candidate notification is transmitted to the entity. As a similar example, candidate notification selector 144 computes a notification selection rate of an entity for a particular type of notification that matches a type of a candidate notification and if that type-specific notification selection rate is above a certain threshold, then the candidate notification is transmitted to the entity.

A selection prediction may take into account multiple factors, such as target entity notification selection rate, notification type, one or more attributes of the target entity, and one or more attributes of the source entity. In many cases, the source entity may have a significant effect on whether a target entity selects a notification. Thus, if a source entity is associated with a relatively high notification selection rate (in terms of other entities selecting notifications about the source entity), then the higher selection prediction for a candidate notification about the source entity and, accordingly, the more likely that candidate notification will be transmitted to a target entity.

In an embodiment, the greater the amount of notification selection history data for a target entity, the greater that that history data is relied upon to generate a prediction of notification selection. For example, if a target entity has been presented twenty notifications in the last two days, then the notification selection rate of the target entity based on those twenty notifications is used solely (or primarily) as a prediction of notification selection. As another example, if a target entity has been presented only one notification in the last two days, then other factors (e.g., the source entity notification selection rate or the notification selection rate of entities similar to the target entity) are used primarily (or solely) to compute a prediction of notification selection. Thus, a reasonable prediction of notification selection may be made for target users who are new to notification system 140 and/or publisher system 130 or have very little online history with those systems.

Rules-Based Model

Predicting notification selection may be performed in a number of ways. For example, rules may be established that count certain notification-related activities (e.g., selections, presentations), each count corresponding to a different score and, based on a combined score, determine whether a target entity will select a notification. For example, a target entity notification selection rate over a certain threshold may result in three points, a source entity notification selection rate over another threshold may result in five points (bringing the total to eight points), and the user selecting on two of the last three notifications may result in ten points (bringing the total to eighteen points). If a user reaches fifteen points, then it is predicted that the user will select the notification.

Rules may be determined manually by analyzing characteristics of notifications, target entities and, optionally, source entities. For example, it may be determined that 56% of target entities who made a new connection to an employee of an organization in a particular industry, sent multiple messages to the new connection, and applied to multiple job positions ultimately selected a notification of a particular type.

A rule-based prediction model has numerous disadvantages. One disadvantage is that it fails to capture nonlinear correlations. For example, if a target entity requests many company page views, then the user might receive a high score, since the target user accumulates, for example, two points for each company page view. However, there may be diminishing returns for each company page view after a certain number. Target entities who are most likely to select a notification may request, for example, between five and eight company page views. Requesting company page views past this may not indicate a significant probability of selecting a notification. In fact, it may even be the case that requesting many company page views is a negative signal. In addition, complex interactions of features cannot be represented by such rule-based prediction models.

Another issue with a rule-based prediction model is that the hand-selection of values is error-prone, time consuming, and non-probabilistic. Hand-selection also allows for bias from potentially mistaken business logic.

A third disadvantage is that output of a rule-based prediction model is an unbounded positive or negative value. The output of a rule-based prediction model does not intuitively map to the probability of notification selection. In contrast, machine learning methods are probabilistic and therefore can give intuitive probability scores.

Machine-Learned Model

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical prediction model, a set of features is specified and a set of training data is identified.

Embodiments are not limited to any particular machine learning technique for generating a model. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

A machine-learned model may output different types of data or values, depending on the input features and the training data. For example, training data may comprise, for each transmission of a notification, multiple feature values, each corresponding to a different feature. Example features include entity profile features (of the target entity and, optionally, the source entity), entity activity features (e.g., a number of messages that the target entity sent in the last two days, a number of profile views by the target entity), a type feature indicating the type of notification, and statistic-related features, such as a notification selection rate of the target entity, and notification selection rate of target entities relative to notifications about the source entity. Some of the features may be cross features, such as the type feature crossed with one or more entity activity features. In order to generate the training data, information about the target entity, the notification, (and, optionally, the source entity) is analyzed to compute the different feature values. In this example, the dependent variable (or label) of each training instance may be whether the target entity (corresponding to the training instance) selected the corresponding notification. Thus, once trained, this machine-learned model is used to predict whether a target entity will select a candidate notification if the candidate notification is transmitted to a computing device of the target entity. The prediction is a “predicted notification selection rate,” which may be a value between 0 and 1.

The training data may include both positive and negative training instances. A negative training instance is one that corresponding to a target entity that did not select a notification that was transmitted to the target entity. The training data may be ensured to include at least a certain percentage of negative instances, such as 30% or 50% of all training instances in the training data.

Initially, the number of features that are considered for training may be significant. After training a model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future models and making predictions.

Change in Visit Probabilities

In an embodiment, another objective for presenting notifications to target entities is to maximize target entity visits to a certain set of one or more target online systems, such as publisher system 130. The greater the likelihood that a notification will cause a target entity to visit (using his/her computing device) a target online system, the more likely the notification will be sent to the target entity.

In a related embodiment, a measure for maximizing target entity visits is change in visit probabilities (or “ΔpVisit”), where one is a probability (or likelihood) of a target entity visiting a target online system given that a candidate notification is sent to the target entity (referred to as “pVisit | send notification”) and the other is a probability (or likelihood) of the target entity visiting a target online system given that the candidate notification is not sent to the target entity (referred to as “pVisit | no notification”). Thus:

ΔpVisit=pVisit |send notification−pVisit |no notification

In some scenarios, a target entity may visit a target online system regardless of whether the target entity receives a notification. In those scenarios, ΔpVisit may be zero or very near zero.

Thus, a model for generating a score for a candidate notification may be the following:

score=pCTR+α*ΔpVisit

where pCTR is a “predicted click through rate” or a predicted notification selection rate and a is a (e.g., manually-tuned) coefficient or weight that dictates how strong the signal from ΔpVisit has on the resulting score.

pVisit may be computed using a machine-learned model. Example features of such a model (referred to herein as the “pVisit model”) include entity profile features, entity online behavior features (e.g., visit history or past visit rate), contextual features (e.g., time of day, day of week, type of target entity device, type of operating system of the target entity device), a badge state feature, a badge number feature, and a last badge update feature that indicates a time since the last badge update. A badge state feature indicates whether a badge is currently associated with an icon of a client application that presents notifications from notification system 140. A badge is a user interface element that is displayed on or adjacent to the icon. If there are no pending notifications for the target entity, then a value for the badge state feature may be 0, indicating no badge; otherwise, the value for the badge state feature may be 1, indicating a badge exists, indicating that there is at least one pending notification. A badge number feature indicates a number that (a) is currently associated with the badge if the badge is to be presented to the target entity at that time or (b) was associated with the badge when the badge was last presented. The number reflects a number of pending notifications.

In order to calculate “pVisit | send notification” and “pVisit | no notification” to generate a ΔpVisit value, two pVisit models may be trained and leveraged. In the case of two models, two different sets of training data/labels/coefficients are generated separately. Thus, for entities to whom no notification is sent, one set of training data is generated, each training instance indicating whether there is a visit within a time window (i.e., pVisit | no notification). For entities to whom a notification sent, another set of training data is generated, each training instance indicating whether there is a visit within a time window (i.e., pVisit | send notification).

The feature values would largely be the same for both models, except for the badge state feature and/or the badge number feature. For example, to generate a value for “pVisit | no notification” for a particular target entity, the value for the badge state feature may be 0, while, to generate a value for “pVisit | send notification” for the particular entity, the value for the badge state feature may be 1. Alternatively, the values for both invocations may be 1. As another example, to generate a value for “pVisit | send notification,” the value for the badge number feature may be one more than the value for the badge number feature to generate a value for to generate a value for “pVisit | no notification” (e.g., five vs. four)

In a related embodiment, the model for generating a score for a candidate notification is the following:

score=pCTR+*ΔpVisitRatio

where ΔpVisitRatio=ΔpVisit/(pVisit | no notification).

Whichever model is used, if the value of “score” for a candidate notification-target entity pair is greater than a threshold T, then the candidate notification is sent to the target entity.

Downstream Interactions

In an embodiment, another objective for presenting notifications to target entities is to maximize a measure of downstream interactions resulting from target entity selections of notifications. The downstream interactions may be viral actions, such as posts, comments, shares, and likes. The downstream interactions may be views and/or selections of certain types of content items, such as content items that are provided by content providers 112-116 and that are associated with content delivery campaigns. For example, if a target entity selects a content item of a first type, then that is considered a relevant downstream interaction. However, if the target entity selects a content item of a second type, then that might not be considered a relevant downstream interaction. (Or downstream interactions of different types of content items may be weighted differently.) As another example, if a content item of a particular type is presented to the target entity, then that may be considered a relevant downstream interaction that is recorded, even though the target entity did not select the content item of the particular type.

Measures of downstream interactions may be based on actions performed by target entities with respect to content that is different than the notifications that directed the target entities to publisher system 130. In an embodiment, a measure of downstream interactions is revenue-centric, where downstream interactions result in revenue to content delivery system 120 or the entity that owns or operates content delivery system 120. Revenue may come from presenting content items from CPM campaigns to target entities, target entities selecting (e.g., clicking on) content items from CPC campaigns, and/or target entities performing certain actions after being presented with content items from CPA campaigns. Revenue generated from downstream interactions may be associated with the target entities (e.g., operating client devices 152-156) that performed the downstream interactions.

Therefore, a new notification decision strategy considers downstream impact. An example formula that is similar to the example formulas above is the following:

score=pCTR+α*ΔpVisitRatio+β*eDI*ΔpVisit

where eDI is an expected downstream interaction measure (e.g., clicks on certain types of content items or revenue) and β is a coefficient or weight that dictates how strong the signal from eDI has on the score.

A value for eDI for a target entity may be calculated in one or more ways. For example, a total revenue generated from a target entity is computed and divided by a number of visits or sessions with a target online system, such as publisher system 130. (A session comprises one or more visits.) A value for the total revenue may be generated by computing, for each content item (presented to the target entity) from a CPM campaign, an amount associated with a content item selection event in which the content item was selected, and then totaling those amounts. The amount associated with a content item selection event may be a bid of the content item or the next highest bid of a content item that was not selected from the content item selection event. The value for the total revenue may also be generated by computing, for each content item (selected by the target entity) from a CPC campaign, an amount associated with a content item selection event in which the content item was selected, and then totaling those amounts.

In an embodiment, the greater the revenue history of a target entity (e.g., in terms of number of sessions or number of content item selection events that resulted in content items being presented to the target entity), the more the revenue value from the target entity is used to generate the value for eDI. Conversely, the lesser the revenue history of a target entity, the less the revenue value from the target entity is used to generate the value for eDI.

In a related embodiment, a machine-learned model is trained based on historical data and is used to generate a value for eDI. Such a model is useful in situations where the amount of revenue history or the number of sessions for a target entity is relatively low. In this embodiment, a prediction of the revenue resulting from a target entity m may be estimated as yₘ=zₘ^{T}bₘ+ϵ, where ϵ is an error term that may be identically independent distributed (IID) with a Gaussian distribution, zm is a feature vector for target entity m, bₘ is a global coefficient vector for target entity features (which coefficients are learned using one or more machine learning techniques), and T is a transpose operation that is used to combine the feature values of zm with the corresponding coefficients or weights of bm. Examples of entity features for zm include profile features (e.g., job title, tenure, job industry) and online behavior features (e.g., life cycle, which indicates an active level of members (e.g., less active members who visit a target online system once a month versus more active members who visit the target online system four days a week for four weeks in a month), click history, and ads footprint history (which may include the number of content items of a particular type viewed and number of conversions or particular actions performed as a result of viewing/selecting certain content items).

Training data for the machine-learned model that computes an estimate or prediction of an amount of downstream interaction comprises multiple training instances, where each training instance corresponds to a different transmission of a notification to a target entity. Some of the training instances may correspond to the same notification but different target entities while some of the training instances may correspond to different notifications but the same target entity. Each training instance includes feature values for each feature of the target entity (such as the profile features mentioned above) and, optionally, for each feature of the notification.

The label for each training instance includes an amount of downstream interaction that resulted from the notification. For example, if the downstream interaction is a number of views of content items of a particular type, then the label may be 0, which may due to the target user not viewing the notification, not selecting the notification, or not going to a view or page of the client application that includes content items of the particular type. If the downstream interaction is a number of clicks of content items of a particular type, then the label may be one, indicating that the target user selected a content item of the particular type as a result of selecting the notification or selecting an icon of the client application after a badge of the icon was updated. If the downstream interaction is an amount of revenue generated for content delivery system 120 as result of the target user viewing and/or selecting content items of a particular type, then the label may be an amount in a particular currency (e.g., dollars, such as $0.38).

In an embodiment, different values of α and β (coefficients for ΔpVisitRatio and eDI*ΔpVisit, respectively) are tested on “live” or actual notifications that are sent to target entities to determine what combination of values for those coefficients result in best performance. Thus, different live experiments are run where candidate notification selector 144 uses a different set of model coefficients on different sets of candidate notifications and tracks, for each set of candidate notifications, how the set of candidate notifications perform, both individually and in the aggregate. Example measures of aggregate performance (in order to determine which combination of coefficients is best) include notification selection rate (or CTR), number of visits or sessions, number of views of downstream content items of a particular type, click through rate of downstream content items of a particular type, total revenue, and revenue per visit. One or more baseline performance metrics may be generated using an old version of the model (e.g., score=pCTR+α*ΔpVisitRatio). Those baseline performance metrics may then be compared to performance metrics generated from experiments (e.g., on 5% website visits) involving a new version of the model (e.g., score=pCTR+α*ΔpVisitRatio+β*eDI*ΔpVisit). For example, if, as a result of increasing the value of β (which means that eDI is becoming more important relative to pCTR and ΔpVisitRatio), the number of notification selections stays the same (or the notification selection rate stays the same) while a measure of actual downstream interactions (e.g., revenue) increases, then that value of β is maintained for a production model or even increased more to determine whether the performance metrics improve yet again.

Example Process

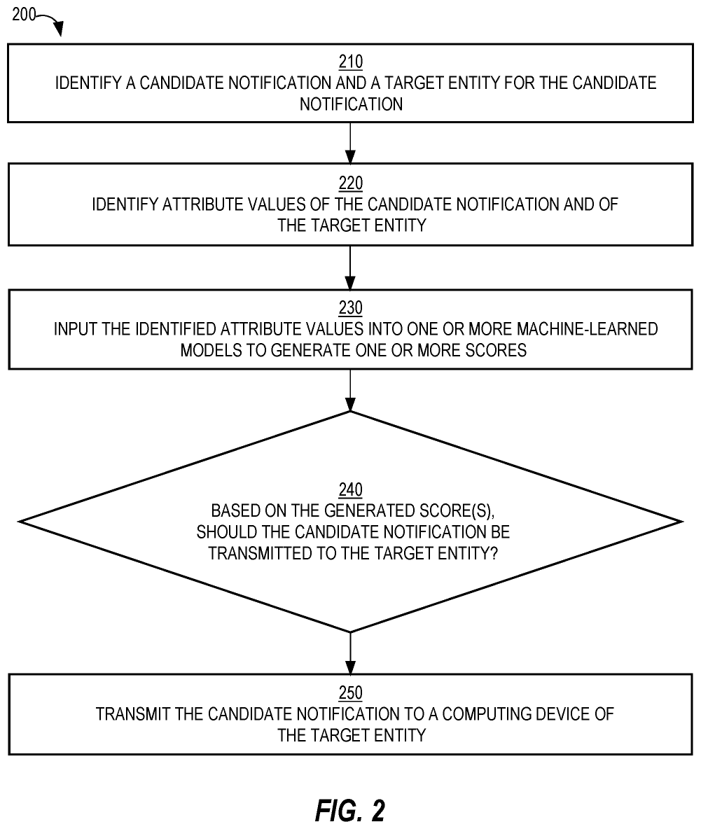

FIG. 2 is a flow diagram that depicts an example process 200 for presenting a candidate notification to a target entity, in an embodiment. Process 200 may be implemented by notification system 140 and, optionally, by content delivery system 120 and publisher system 130. Process 200 may be preceded by storing event data (e.g., notification selection history, content item selection history), storing entity profile data, generating training instances for different models based on the event data and the entity profile data, and training the different models using one or more machine-learning techniques.

At block 210, a candidate notification and a target entity for the candidate notification are identified. Block 210 may involve identifying an action that is performed (by a source entity) in an online connection platform (e.g., a share, a like, a comment, a profile update) or identifying a significant date of a source entity (e.g., a person's birthday, work anniversary, or other significant day). Once the action or significant date of the source entity is identified, one or more connections of the source entity are identified. A connection of the source entity is considered a target entity. Thus, the candidate notification may be identified in real-time or near real-time in response to identifying the action.

At block 220, values for one or more attributes of the candidate notification and one or more attributes of the target entity are identified. Example attributes of the candidate notification include type of notification, time of day, day of week, and attributes of the source entity of the candidate notification (e.g., profile attributes and a notification selection rate of notifications initiated by the source entity). Example attributes of the target entity include profile attributes, notification selection rate, and other online history (e.g., visit history, downstream interaction history, etc.).

At block 230, the identified values are input to one or more machine-learned models that each generate a score. For example, there may be one machine-learned model to predict a notification selection, another machine-learned model to predict a visit, and another machine-learned model to predict an amount of downstream interactions resulting from transmitting the candidate notification (e.g., views, clicks, etc.).

At block 240, the score(s) generated in block 230 are used to determine whether to transmit the candidate notification to the target entity. For example, a score formula like the one described above may be used to generate a final score for the candidate notification (e.g., final score=pCTR+α*ΔpVisitRatio+β*eDI*ΔpVisit). If the final score is above a particular threshold, then the determination is positive. If the determination is positive, then process 200 proceeds to block 250.

At block 250, the candidate notification is transmitted to the target entity. Block 250 may involve causing notification data to be transmitted over a computer network to a computing device of the target entity, where the computing device executes a client application associated with notification system 140 or publisher system 130. The client application, in response to receiving the notification data, mat update a badge of an icon that represents the client application and that is displayed on a screen (e.g., a touchscreen) of the computing device. The update may be increasing a number of the badge by one or by displaying the badge in the first place. If the target entity selects the icon or the badge, then the client application is opened and a view of data is provided. The data provided may be a set of one or more pending notifications or a set of content items that is independent of the notification. Alternatively, block 250 may involve transmitting a push notification to a computing device of the target entity.

Blocks 210-250 may be repeated thousands or tens of thousands of times per minute for different candidate notification-target entity pairs on a single computing device or across multiple computing devices.

Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

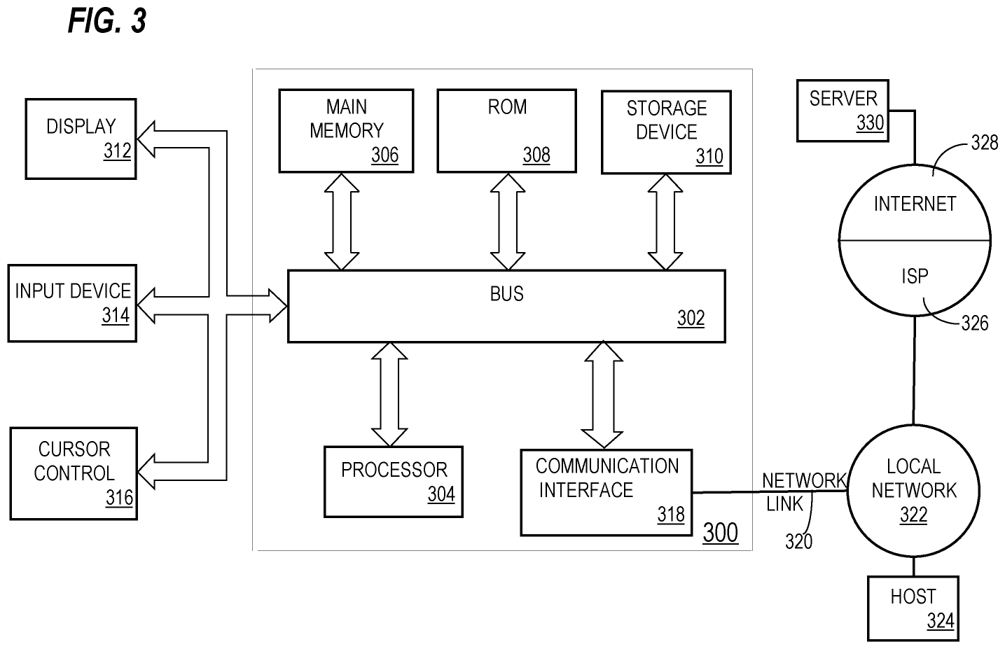

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a candidate notification for a target entity;
determining an entity selection rate of the candidate notification by the target entity;
based on the candidate notification, determining a probability of the target entity visiting a target online system;
based on online history of the target entity, determining a measure of downstream interaction by the target entity relative to one or more online systems;
based on the entity selection rate, the probability, and the measure of downstream interaction by the target entity, generate a score for the candidate notification;
based on the score, determining whether to transmit data about the candidate notification over a computer network to a computing device of the target entity;
wherein the method is performed by one or more computing devices.

2. The method of claim 1, wherein determining the entity selection rate comprises:
identifying a first set of feature values of the candidate notification;
identifying a second set of feature values of the target entity;
inputting the first set of feature value and the second set of feature values into a machine-learned model that computes predicted entity selection rates, wherein the entity selection rate is a predicted entity selection rate.

3. The method of claim 1, wherein the downstream interaction comprises (a) views of content items of a first type that is different than a second type or (b) selections of content items of the first type.

4. The method of claim 1, wherein:
determining the measure of downstream interaction comprises identifying a history of downstream interactions by the target entity relative to one or more target online systems that present notifications and a plurality of types of content items;
the measure of downstream interactions is based on the history of downstream interactions.

5. The method of claim 1, wherein determining the measure of downstream interaction comprises:
identifying a plurality of feature values that is associated with the target entity;
inputting the plurality of feature values into a machine-learned model that computes the measure of downstream interaction.

6. The method of claim 5, further comprising, prior to inputting the plurality of feature values into the machine-learned model:
generating training data based on event data that pertains to downstream interactions of a plurality of entities;
wherein the training data comprises (1) a first training instance that comprises (i) a first label indicating a first measure of downstream interaction by a first target entity and (ii) a first plurality of feature values associated with the first target entity and (2) a second training instance that comprises (iii) a second label indicating a second measure of downstream interaction, that is different than the first measure of downstream interaction, by a second target entity that is different than the first target entity and (iv) a second plurality of feature values associated with the second target entity;
training, using one or more machine learning techniques, the machine-learned model based on the training data.

7.The method of claim 1, wherein determining the probability comprises:
determining a first probability of the target entity visiting a target online system if the data about the candidate notification is transmitted to the target entity;
determining a second probability of the target entity visiting the target online system if the data about the candidate notification is not transmitted to the target entity.

8. The method of claim 7, further comprising:
combining the measure of downstream interaction with a difference between the first probability and the second probability to generate a combined value;
wherein generating the score is based on the combined value.

9. The method of claim 7, further comprising:
generating a ratio based on (1) a difference between the first probability and the second probability and (2) the second probability;
wherein generating the score is based on the ratio.

10. The method of claim 1, wherein determining whether to transmit the data comprises comparing the score to a threshold, the method further comprising:
transmitting the data if the score is above the threshold.

11. One or more storage media storing instructions which, when executed by one or more processors, cause:
identifying a candidate notification for a target entity;
determining an entity selection rate of the candidate notification by the target entity;
based on the candidate notification, determining a probability of the target entity visiting a target online system;
based on online history of the target entity, determining a measure of downstream interaction by the target entity relative to one or more online systems;
based on the entity selection rate, the probability, and the measure of downstream interaction by the target entity, generate a score for the candidate notification;
based on the score, determining whether to transmit data about the candidate notification over a computer network to a computing device of the target entity.

12. The one or more storage media of claim 11, wherein determining the entity selection rate comprises:
identifying a first set of feature values of the candidate notification;
identifying a second set of feature values of the target entity;
inputting the first set of feature value and the second set of feature values into a machine-learned model that computes predicted entity selection rates, wherein the entity selection rate is a predicted entity selection rate.

13. The one or more storage media of claim 11, wherein the downstream interaction comprises (a) views of content items of a first type that is different than a second type or (b) selections of content items of the first type.

14. The one or more storage media of claim 11, wherein:
determining the measure of downstream interaction comprises identifying a history of downstream interactions by the target entity relative to one or more target online systems that present notifications and a plurality of types of content items;
the measure of downstream interactions is based on the history of downstream interactions.

15. The one or more storage media of claim 11, wherein determining the measure of downstream interaction comprises:
identifying a plurality of feature values that is associated with the target entity;
inputting the plurality of feature values into a machine-learned model that computes the measure of downstream interaction.

16. The one or more storage media of claim 15, wherein the instructions, when executed by the one or more processors, further cause, prior to inputting the plurality of feature values into the machine-learned model:
generating training data based on event data that pertains to downstream interactions of a plurality of entities;
wherein the training data comprises (1) a first training instance that comprises (i) a first label indicating a first measure of downstream interaction by a first target entity and (ii) a first plurality of feature values associated with the first target entity and (2) a second training instance that comprises (iii) a second label indicating a second measure of downstream interaction, that is different than the first measure of downstream interaction, by a second target entity that is different than the first target entity and (iv) a second plurality of feature values associated with the second target entity;
training, using one or more machine learning techniques, the machine-learned model based on the training data.

17. The one or more storage media of claim 11, wherein determining the probability comprises:
determining a first probability of the target entity visiting a target online system if the data about the candidate notification is transmitted to the target entity;
determining a second probability of the target entity visiting the target online system if the data about the candidate notification is not transmitted to the target entity.

18. The one or more storage media of claim 17, wherein the instructions, when executed by the one or more processors, further cause:
combining the measure of downstream interaction with a difference between the first probability and the second probability to generate a combined value;
wherein generating the score is based on the combined value.

19. The one or more storage media of claim 17, wherein the instructions, when executed by the one or more processors, further cause:
generating a ratio based on (1) a difference between the first probability and the second probability and (2) the second probability;
wherein generating the score is based on the ratio.

20. The one or more storage media of claim 11, wherein determining whether to transmit the data comprises comparing the score to a threshold, the method further comprising:
transmitting the data if the score is above the threshold.
